(19) United States
(12) Patent Application Publication
(10) Pub. No.: US 2026/0277534 A1
(43) Pub. Date: Sep. 17, 2026

(54) METHOD, APPARATUS AND SYSTEM FOR AUDIO PROCESSING

(71) Applicant: Cirrus Logic International Semiconductor Ltd., Edinburgh (GB)

(72) Inventors: Reid LEE, Austin, TX (US); David LADOLCETTA, Austin, TX (US); K. Joshua BODON, Austin, TX (US); Jace SCOTT, Austin, TX (US)

(73) Assignee: Cirrus Logic International Semiconductor Ltd., Edinburgh (GB)

(21) Appl. No.: 19/076,289

(22) Filed: Mar. 11, 2025

(51) Int. Cl. G06F 3/16

(52) U.S. Cl. CPC G06F 3/165; G06F 3/162

(57) ABSTRACT

A method of processing an audio signal in a laptop computing device may be provided. The method may comprise: determining an audio context of the audio signal; determining an acoustic configuration of the laptop computing device; determining one or more audio effects in dependence on the audio context and the acoustic configuration of the laptop computing device; and applying the one or more audio effects to the audio signal to generate a processed audio signal.

### TECHNICAL FIELD

The present disclosure relates to methods, apparatuses, and systems for audio processing.

### BACKGROUND

Audio processing of audio signals in laptop computing devices is typically orchestrated by software applications or by audio drivers associated with audio endpoint devices for outputting the audio signals. In operating systems such as the Windows Operating System from Microsoft Corporation, an audio driver associated with an audio endpoint device may cause one or more digital signal processing (DSP) effects (“audio effects”) to be applied to an audio signal. To do so, the audio driver may cause the operating system to instantiate a software audio processing object (APO) configured to apply a respective audio effect to the audio signal.

### SUMMARY

According to a first aspect of the disclosure, there is provided a method of processing an audio signal in a laptop computing device. The audio signal for outputting by an audio endpoint device. The method comprises: determining an audio context of the audio signal; determining an acoustic configuration of the laptop computing device; determining one or more audio effects in dependence on the audio context and the acoustic configuration of the laptop computing device; and applying the one or more audio effects to the audio signal to generate a processed audio signal.

The audio context may comprise one or more of: a type of an application from which the audio signal derives; a specific application from which the audio signal derives; a category of audio content included in the audio signal.

The type of the application may comprise any one of: a voice over internet protocol, VOIP, application; a game; a media player; a web browser application.

The category of audio content may comprise: movie content; media content; game chat content; speech content; communications content; alert content; sound effect content; game media content; game effect content.

The acoustic configuration may comprise any one or more of: a type of the audio endpoint device; a configuration of the audio endpoint device; a characteristic of ambient sound in a vicinity of the laptop computing device; a distance or a position of a user relative to the audio endpoint device.

The characteristic of ambient sound may be indicative of a predetermined type of sound. The predetermined type of sound may be one or both of: a predetermined type of noise; speech.

The characteristic of the ambient sound may comprise a characteristic of one or more selected frequency components of the ambient sound. The characteristic of the one or more selected frequency components of the ambient sound may comprise a power level of the one or more selected frequency components of the ambient sound.

The audio endpoint device may comprise one or more speakers of the laptop computing device, and the acoustic configuration of the laptop computing device may comprise any one or more of: an orientation of the one or more speakers; an orientation of a display of the laptop computing device; a number of the one or more speakers; a contortion of the laptop computing device.

The one or more audio effects may comprise any one or more of: baseline speaker protection; excursion prevention; resonance distortion prevention; rattle distortion reduction; distortion limiting; crossover filtering; spatial processing; equalization; virtual and/or dynamic bass enhancement.

The method may further comprise: determining that the audio signal derives from an application associated with a currently active user account of the laptop computing device; and selectively determining the audio context of the audio signal in dependence on said determination.

The determining the one or more audio effects may comprise selecting the one or more audio effects from a predetermined audio effect mapping associated with the audio context, the predetermined audio effect mapping defining a mapping between: respective ones of a plurality of different acoustic configurations or selected elements thereof; and respective sets of one or more audio effects.

Each of the sets of the one or more audio effects defined in the predetermined audio effect mapping may be configured to compensate for one or more characteristics of the audio endpoint device.

The method may further comprise determining the one or more audio effects in dependence on a currently active user account of the laptop computing device.

The audio signal may be a first audio signal for outputting by the audio endpoint device and the one or more audio effects may be one or more first audio effects. The method may further comprise: determining an audio context of a second audio signal for outputting by the audio endpoint device; determining one or more second audio effects in dependence on the audio context of the second audio signal and the acoustic configuration of the laptop computing device; and applying the one or more second audio effects to the second audio signal; wherein the processed audio signal may comprise: a first component corresponding to the fist audio signal with the one or more first audio effects applied thereto; and a second component corresponding to the second audio signal with the one or more second audio effects applied thereto.

The method may further comprise causing the processed audio signal to be output by the audio endpoint device.

The audio endpoint device may comprise one or more speakers of the laptop computing device.

The audio endpoint device may be a first audio endpoint device, the acoustic configuration of the laptop computing device may be associated with the first audio endpoint device, and the processed audio signal may be a first processed audio signal. The method may further comprise: determining a second audio context of a second audio signal for outputting by a second audio endpoint device, different from the first audio endpoint device; determining a second acoustic configuration of the laptop computing device associated with the second audio endpoint device; determining one or more second audio effects in dependence on the second audio context and the second acoustic configuration of the laptop computing device; and applying the one or more second audio effects to the second audio signal to generate a second processed audio signal.

The method may further comprise causing the first processed audio signal and the second processed audio signal to be output substantially simultaneously by the respective first and the second audio endpoint devices.

According to a second aspect of the disclosure, there is provided a method of determining one or more audio effects for processing an audio signal in a laptop computing device. The method comprises: determining an audio context of the audio signal; determining an acoustic configuration of the laptop computing device; determining one or more audio effects in dependence on the audio context and the acoustic configuration of the laptop computing device; and outputting audio effect data indicative of the one or more audio effects to be applied to the audio signal.

According to a third aspect of the disclosure, there is provided an apparatus comprising: processing circuitry; and memory comprising software instructions which when executed by the processing circuitry cause the processing circuitry to: determine an audio context of an audio signal for outputting by an audio endpoint device of or communicatively coupled to a laptop computing device; determine an acoustic configuration of the laptop computing device; determine one or more audio effects in dependence on the audio context and the acoustic configuration of the laptop computing device; and apply the one or more audio effects to the audio signal to generate a processed audio signal.

The memory may further comprise software instructions which when executed by the processing circuitry cause the processing circuitry to output the one or more processed audio signals by the audio endpoint device.

According to a fourth aspect of the disclosure, there is provided a system of a laptop computing device. The system comprises: main circuitry, comprising: a central processor; and memory comprising software instructions which, when executed by the central processor, cause the central processor to output an audio signal. The system further comprises an audio effect controller configured to: determine an audio context of the audio signal; determine an acoustic configuration of the laptop computing device; determine one or more audio effects in dependence on the audio context and the acoustic configuration of the laptop computing device; and output the one or more audio effects. The system further comprises audio effect circuitry configured to: receive the audio signal; and apply the one or more audio effects to the audio signal to generate a processed audio signal.

The system may be configured to output the processed audio signal by an audio endpoint device of or communicatively coupled to the laptop computing device.

According to a fifth aspect of the disclosure, there is provided an electronic device comprising the apparatus of the third aspect of the disclosure or a system of the fourth aspect of the disclosure.

The electronic device may comprise any one of a laptop computing device, a wearable device, a mobile computing device, a tablet computer, a games console, a remote control device, a home automation controller or a domestic appliance, a toy, a robot, an audio player, a video player, a mobile telephone, and a smartphone.

According to a sixth aspect of the disclosure, there is provided a method of processing an audio signal in a laptop computing device. The method comprises: determining a system context, the system context comprising at least a contortion of the laptop computing device; determining one or more audio effects in dependence on the system context of the laptop computing device; and applying the one or more audio effects to the audio signal to generate a processed audio signal.

According to a seventh aspect of the disclosure, there is provided at least one non-transitory machine-readable medium comprising software instructions which, when executed by processing circuitry, cause the processing circuitry to implement the method of any one of the first, second, and sixth aspects of the disclosure.

Throughout this specification the word “comprises”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 is schematic diagram of a known system;

FIG. 2 is a flow diagram illustrating processing of an audio signal by the system of FIG. 1;

FIG. 3 is schematic diagram of a system according to the present disclosure;

FIG. 4 is a flow diagram illustrating processing of an audio signal by the system of FIG. 3; and

FIG. 5 is a schematic diagram of a variation of the system of FIG. 3.

### DESCRIPTION OF EMBODIMENTS

Embodiments of the present disclosure relate to techniques for processing audio signals in laptop computing devices that optimize audio performance of the laptop computing device.

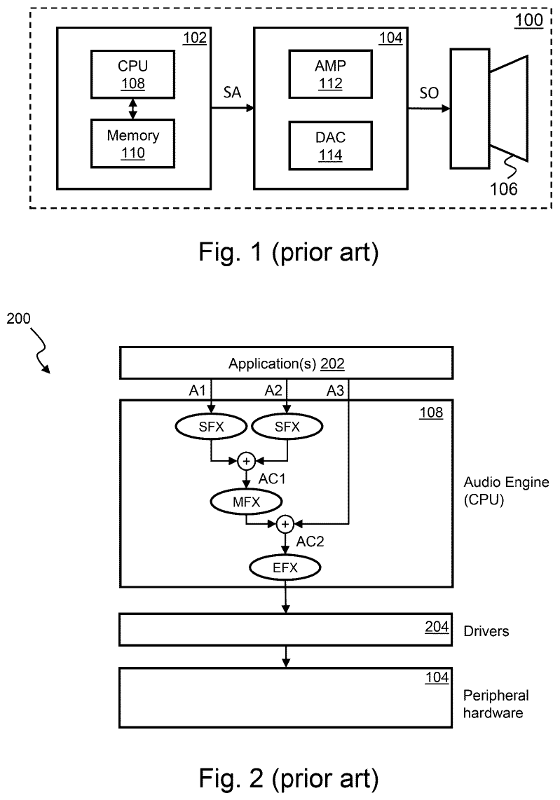

FIG. 1 is a schematic diagram of a known system 100, such as a laptop computing device. For clarity of explanation, various elements of the laptop computing device are not shown in FIG. 1.

The system 100 comprises main circuitry 102, peripheral audio processing circuitry 104, and an audio transducer 106.

The main circuitry 102 comprises a central processing unit (CPU) 108 and memory 110. The memory 110 may store instructions which, when executed by the CPU 108, may cause the CPU 108 to run one or more applications within an operating system (OS) executed by the CPU 108. The one or more applications may each generate an audio signal A for outputting by the audio transducer 106.

The CPU 108 may be configured to execute an audio engine (instructions for which may also be stored in the memory 110) to process the audio signal(s) A to thereby generate a processed audio signal SA. For example, when the audio signal(s) A comprise a plurality of audio signals, such processing may include combining (which may be referred to as “mixing”) the plurality of audio signals such that the processed audio signal SA comprises respective components derived from each of the plurality of audio signals A.

The processed audio signal SA may be stored in the memory 110 and/or transmitted to the peripheral audio processing circuitry 104. Communication between the main circuitry 102 and the peripheral audio processing circuitry 104 may be facilitated by one or more audio drivers associated with the peripheral audio processing circuitry 104. The audio driver(s) may be stored in the memory 110 and executed by the CPU 108.

The peripheral audio processing circuitry 104 may comprise an amplifier 112 and a digital-to-analog converter (DAC) 114. The DAC 114 may be configured to convert the processed audio signal SA to an analog audio signal SO to be output by the audio transducer 106. The amplifier 112 may be configured to amplify the processed audio signal SA for output as the output signal SO. Amplification may be performed in the digital domain (before conversion by the DAC 114) or in the analog domain (after conversion by the DAC 114). The output signal SO may then be output to the audio transducer 106 to be played back to a user.

To attempt to enhance the quality of the output signal SO as output by the audio transducer 106, the processed audio signal SA may be generated in dependence on one or more algorithms. Such algorithms may each implement a specific digital signal processing (DSP) effect (an “audio effect”). For example, the audio signal(s) A may have had one or more audio effects applied thereto prior to being output by the application(s). Additionally, or alternatively, the audio engine running on the CPU 108 may be configured to apply one or more audio effects to the audio signal(s) A during generation of the processed audio signal SA. Accordingly, the application of audio effect(s) may be invoked by the application(s) themselves and/or by the audio driver(s) associated with the peripheral audio processing circuitry 104.

Audio effects invoked by the application(s) may be predetermined and fixed. Such effects may be based on a category of audio content that the application(s) output. Such audio categories may include but are not limited to movie, media, game chat, speech, communications, alerts, sound effects, game media, and game effects. For example, a voice over internet protocol (VOIP) application may typically output audio signals comprising speech. As such, a VOIP application may be configured to apply one or more predetermined and fixed audio effects to audio signals intended to enhance speech.

Audio effects invoked by the audio driver(s) may be selected depending on the audio category of the audio signal(s) A. The audio category of the audio signal(s) A may be set by the application(s) having output them. The audio category may be indicated by metadata incorporated in corresponding audio sessions running on the audio engine. The audio driver(s) may map the audio category of the audio signal(s) A to a particular mode of the audio driver(s) which may define a predetermined set of audio effects. The audio driver(s) may additionally cause predetermined baseline audio effects to be applied to the audio signal(s) A to implement e.g. baseline speaker protection. Such baseline audio effects may be applied to all audio signals to be output by the audio transducer 106, e.g. irrespective of their audio category.

Audio effects are conventionally applied in software by audio processing objects (APOs). In the Windows 10 and 11 operating systems from Microsoft Corporation, an APO can be one of a stream effect (SFX) APO, a mode effect (MFX) APO, and an endpoint effect (EFX) APO. SFX APOs apply audio effects directly to individual audio signals output from applications. MFX APOs apply audio effects to all audio signals mapped to the same audio driver mode, subsequent to those signals being combined. EFX APOs apply audio effects to all audio signals output by the same audio output device (referred to as an endpoint), subsequent to those signals being combined. The baseline audio effects described above may be implemented by way of an EFX APO, for example.

FIG. 2 is a flow diagram illustrating an example audio processing flow 200 for the system 100 shown in FIG. 1.

One or more applications 202 running on the main circuitry 102 may each generate an audio signal. In the example shown, first, second, and third audio signals A1, A2, A3 are generated.

The first and second audio signals A1, A2 may each belong to the same audio category, as set by the application(s) 202 having output the first and second audio signals A1, A2 and as indicated in corresponding audio sessions. The audio category may comprise “media”, for example. The first and second audio signals A1, A2 may not have had any audio effects applied thereto upon being output by the audio application(s) 202.

The third audio signal A3 may have had one or more audio effects applied thereto by one of the applications 202 having output the third audio signal A3. For example, the third audio signal A3 may have been output from a VOIP application having implemented its own audio effects. Accordingly, the VOIP application may request one or more audio driver(s) 204 associated with the peripheral audio processing circuitry 104 to operate in a “raw” mode to apply baseline endpoint effects only to the signal A3 to prevent further audio effect processing of the third audio signal A3. The application 202 may not have set an audio category of the third audio signal A3 in the corresponding audio session.

The audio driver(s) 204 may cause the audio engine running on the CPU 108 to apply a predetermined set of audio SFX and audio MFX to the audio signals A1 and A2 in dependence on their audio category by instantiating corresponding APOs. The audio SFX may be applied individually to each of the signals A1, A2. The signals A1, A2 may then be combined to obtain a first combined signal AC1 and the audio MFX applied thereto. The audio engine may not apply any SFX or MFX to the audio signal A3 in accordance with the request from the application which output the audio signal A3 that this signal should remain unprocessed or “raw”. The audio signal A3 may then be combined with the first combined audio signal AC1 to obtain a second combined audio signal AC2, and predetermined audio EFX (e.g. implementing baseline speaker protection) may be applied thereto by way of a corresponding EFX APO.

In the conventional arrangement shown in FIG. 1 and described with reference to FIG. 2, the determination of the audio effects to be applied to audio signals is based on a limited set of factors relating to the type and content of audio being generated in a laptop computing device. The inventors have realised, however, that the configurable nature of computing devices, such as laptop computing devices and foldable tablets, can lead to deterioration in acoustic performance which is not addressed by arrangements such as those described above.

Embodiments of the present disclosure aim to address or least ameliorate the above issues by determining one or more audio effects for application to one or more audio signals to be output by a laptop computing device in dependence on a determined system context of the laptop computing device, where the system context may provide for a more granular or holistic consideration of aspects of the laptop computing device affecting its audio performance. In doing so, the embodiments of the present disclosure may provide for laptop computing devices having an improved audio performance relative to known devices.

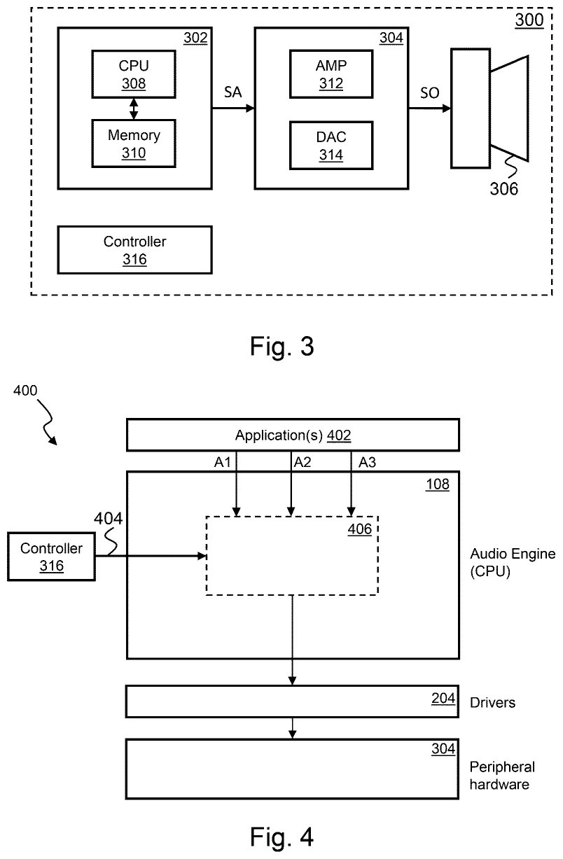

FIG. 3 is a schematic diagram of a system 300 which may be implemented in a laptop computing device (not shown), in accordance with embodiments of the present disclosure. For clarity of explanation, various elements of the system 300 are not shown in FIG. 3. When integrated into a laptop computing device, the system 300 may comprise additional elements.

The system 300 comprises main circuitry 302, peripheral audio circuitry 304, and one or more speakers 306 (which may be referred to as a first audio endpoint device). The one or more speakers 306 may be integrated within the laptop computing device. The system 300 additionally comprises an audio effect controller 316.

The main circuitry 302 may be similar to the main circuitry 102 of the system 100 of FIG. 1 and comprises a CPU 308 and a memory 310. The memory 310 may store instructions which, when executed by the CPU 308 may cause the CPU 308 to run one or more applications within an operating system (OS) executed by the CPU 308. The one or more applications may each generate an audio signal A for outputting by the one or more speakers 306. In addition to the CPU 308, the main circuitry 302 may comprise a digital signal processor (DSP) (not shown) integrated on the same system-on-chip (SoC) as the CPU 308.

The CPU 308 may be configured to execute an audio engine (instructions for which may be stored in the memory 310) to process the audio signal(s) A to generate a processed audio signal SA. For example, when the audio signal(s) A comprise a plurality of audio signals, such processing may include combining (which may be referred to as “mixing”) the plurality of audio signals such that the processed audio signal SA comprises respective components derived from each of the plurality of audio signals.

The processed audio signal SA may be stored in the memory 310 and/or transmitted to the peripheral audio processing circuitry 304. Communication between the main circuitry 302 and the peripheral audio processing circuitry 304 may be facilitated by one or more audio drivers associated with the peripheral audio processing circuitry 304. The audio driver(s) may be stored in the memory 310 and executed by the CPU 308.

The peripheral audio processing circuitry 304 may be similar to the peripheral audio processing circuitry 104 of the system 100 of FIG. 1. The peripheral audio processing circuitry 304 may comprise an amplifier 312 and a digital-to-analog converter (DAC) 314. The DAC 314 may be configured to convert the processed audio signal SA to an analog audio signal SO to be output by the speaker(s) 306. The amplifier 312 may be configured to amplify the processed audio signal SA for output as the output signal SO. Amplification may be performed in the digital domain (before conversion by the DAC 314) or in the analog domain (after conversion by the DAC 314). The peripheral audio processing circuitry 304 may additionally comprise a digital signal processor (DSP) (not shown). The output signal SO may then be output to the speaker(s) 306 to be played back to a user.

In contrast to the system 100 shown in FIG. 1, the system 300 additionally comprises the audio effect controller 316. The audio effect controller 316 may be implemented in any one of hardware, software, firmware, or any combination thereof. In the example shown in FIG. 3, the audio effect controller 316 is shown as separate from both the main circuitry 302 and the peripheral audio processing circuitry 304. It will be appreciated, however, that the audio effect controller 316 may be implemented by or integrated into the main circuitry 302 or the peripheral audio processing circuitry 304. As an illustrative example, the audio effect controller 316 may be implemented by software stored in the memory 310 and executed by the CPU 308.

The audio effect controller 316 may be configured to determine a system context of the laptop computing device into which the system 300 is integrated. The audio effect controller 316 may determine one or more audio effects to be applied to one or more of the audio signal(s) A in dependence on the determined system context. The determined audio effect(s) may be configured to enhance an audio quality of one or more of the audio signal(s) A when played back by the speaker(s) 306. As will be discussed further below, in examples where the audio signal(s) A comprise a plurality of audio signals, the audio effect controller 316 may attempt to determine audio effects to be applied to each of the plurality of audio signals A to enhance the audio quality of each. If such audio effects are conflicting, the audio effect controller 316 may prioritise enhancing the audio quality of a selected one or more of the audio signal(s) A.

The system context may comprise an audio context and/or an acoustic configuration, each of which will now be described.

The audio context of each of the audio signal(s) A may indicate one or more audio categories, which may be used to choose desirable audio effects to be applied to one or more of the audio signal(s) A. As noted above with reference to FIGS. 1 and 2, such audio categories may comprise one or more of audio; speech; movie; media; game chat; communications; alerts; sound effects; game media; and game effects. However, it will be appreciated that the present disclosure is not so limited and that other types of audio content may be indicated by the audio context of an audio signal. For example, the audio context may indicate more broadly a type of or a specific application which generated the audio signal(s) A. Examples of types of application include but are not limited to media, VOIP, system, internet browser, etc.

The audio effect controller 316 may determine the audio context of each of the audio signals(s) A in any suitable way. For example, the audio effect controller 316 may query the OS (e.g. by way of an audio application interface (API), such as the Windows Audio Session API (WASAPI)) to determine an audio context of one or more currently active audio sessions corresponding to the audio signal(s) A. The audio context of such sessions may indicate a type of audio content included in the audio signal corresponding to that audio session.

For example, the audio context of an active audio session may comprise an audio category indicated in the audio session. The audio category may have been set by the application having output the audio signal A corresponding to that audio session.

Additionally, or alternatively, the audio context of an active audio session may comprise a type of or a specific application indicated in the active audio session as having output the audio signal A corresponding to that audio session. In such examples, the audio context of each of the audio signal(s) A may comprise the type of or the specific application having output the respective audio signal(s) A as indicated in the corresponding audio session. Application types may include but are not limited to: voice over internet protocol, VOIP, applications; games; media players; web browsers. The type of an application having output an audio signal A may be indicative of at least a typical type of audio content output by that application.

For audio signal(s) output by VOIP applications such as Teams (RTM) or Zoom (RTM), the corresponding audio context may indicate that the audio signal(s) were output by a VOIP application and may additionally indicate whether the VOIP application is currently hosting a meeting. Including this additional information in the audio context may provide a more granular indication of the audio content included in the corresponding audio signal A. For example, if the VOIP application is currently hosting a meeting, the audio signal A may be likely to comprise speech content. Whereas if the VOIP application is not currently hosting a meeting, the audio signal A may be likely to comprise audio content other than speech content, such as notification or alert content, for example. In these examples, the audio effect controller 316 may be configured to determine whether the corresponding VOIP application is currently hosting a meeting by determining whether there are active input and output audio sessions associated with the VOIP application. If there are both active input and output audio sessions associated with the VOIP application, the audio effect controller 316 may determine that the VOIP is currently hosting a meeting. If there are one or more active audio output sessions associated with the VOIP application but there are no active audio input sessions associated with the VOIP application, the audio effect controller 318 may determine that the VOIP application is not currently hosting a meeting.

In addition to or as alternative to determining the audio context of each of the audio signal(s) A in the ways described above, the audio effect controller 316 may be configured to determine the audio context of each of the audio signal(s) A by processing the audio signal(s) A to characterise their audio content (e.g. in real-time). The audio effect controller 316 may employ any suitable algorithm to perform such characterization. Such characterization may indicate the type of audio content included in the audio signal(s) A.

In the examples described above relating to system context comprising the audio context of each of the audio signal(s) A, it may be assumed that each of the audio signals(s) A has an audio context that is supported by the audio effect controller 316. The audio effect controller 316 may be configured to support one or more predetermined audio contexts for which it may be operable to determine suitable audio effect(s) for corresponding audio signals. Accordingly, to ensure that only audio signal(s) having a supported audio context are factored in to the determination of the one or more audio effects described above, the audio effect controller 316 may be configured to determine that the audio context of each of the audio signal(s) A is supported by the audio effect controller 316, and to selectively determine the one or more audio effects for application to one or more of the audio signal(s) A in dependence on this determination.

It will be appreciated that a laptop computing device into which the system 300 is integrated may run multiple user accounts concurrently. Such multiple user accounts may include a currently active user account and one or more background user accounts. In such examples, the audio signal(s) A, which are to be output by the one or more speakers 306, may be associated with the currently active user account. While background user account(s) may not be operable to cause audio signals to be output by the one or more speakers 306, the background user account(s) may still cause active audio sessions to be generated.

Accordingly, currently active audio sessions of the laptop computing device may include a first subset associated with the currently active user account (i.e. corresponding to the audio signal(s) A) and a second subset associated with background user account(s) (e.g. corresponding to one or more audio signals A′ generated by application(s) running in the background user account(s)). In such examples, it may be desirable to prevent the audio effect controller 316 from erroneously determining the audio context of the audio signal(s) A′ during determination of the audio context of the audio signals(s) A, which may result in the determination of sub-optimal audio effects for processing the audio signal(s) A.

Accordingly, the audio effect controller 316 may be configured to determine that the audio signal(s) A are associated with the currently active user account of the laptop computing device. The audio effect controller 316 may then selectively determine the audio context of the audio signal(s) A in dependence on said determination.

For example, the audio effect controller 316 may be configured to query the OS to determine which of the currently active audio sessions are associated with the currently active user account of the laptop computing device to identify the audio signal(s) A. The audio effect controller 316 may selectively determine the audio context of the audio signal(s) A by selectively querying active audio session(s) corresponding to the audio signal(s) A to determine the audio context of each of said audio session(s) and/or by selectively processing the audio signal(s) A to characterise their audio content.

As noted above, in addition to or as an alternative to the system context comprising the audio context of each of the audio signal(s) A, the system context may comprise an acoustic configuration of a laptop computing device into which the system 300 may be integrated.

The acoustic configuration of the laptop computing device may comprise or may be indicative of any one or more of: a type of audio endpoint device for outputting the audio signal(s) A (e.g. by way of the processed audio signal SA); a configuration of the audio endpoint device for outputting the audio signal(s) A; a distance or a position of a user relative to the audio endpoint device for outputting the audio signal(s) A; a characteristic of ambient sound in a vicinity of the laptop computing device.

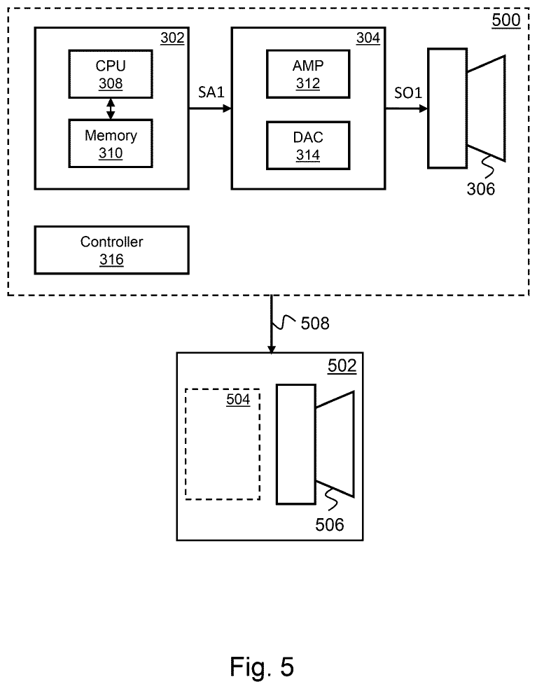

It is to be appreciated that while in the example shown in FIG. 3, the type of audio endpoint device for outputting audio signal(s) is the one or more speakers 306, in other examples, such as the example shown in FIG. 5, the laptop computing device may output audio signals to other types of audio endpoint devices communicatively coupled therewith, such as headphones (wireless or wired), wireless speaker(s) or the like.

In the example shown in FIG. 3, the configuration of the audio endpoint device for outputting the audio signal(s) A (i.e. the speaker(s) 306) may comprise a number of the one or more speakers 306 or an orientation of the one or more speakers 306. The audio effect controller 316 may be configured to determine the configuration of the one or more speakers 306 by querying the OS. For example, in examples where acoustic configuration comprises the orientation of the one or more speakers 306, the audio effect controller 316 may determine the orientation of the one or more speakers by way of querying the OS to determine a current orientation of the laptop computing device (e.g. as monitored by sensors of the laptop computing device) or a current orientation of a display of the laptop computing device, each of which may be indicative of the orientation of the one or more speakers 306.

The audio effect controller 316 may determine the distance or the position of the user relative to the audio endpoint device for outputting the audio signal(s) A (e.g. the speaker(s) 306 in the example shown in FIG. 3) in any suitable way. For example, the audio effect controller 316 may measure or cause to be measured the position or the distance of the user relative to the audio endpoint device for outputting the audio signal(s) A based one or more sensors of or communicatively coupled to the laptop computing device. The one or more sensors may each comprise any type sensor operable to sense a parameter or parameters indicative of the position or the distance of the user relative to the audio endpoint device for outputting the audio signal(s) A. For example, the audio effect controller 316 may measure or cause to be measured the position or distance of the user by way of (e.g. ultrasonic) ranging performed by the one or more speakers 306 or by (e.g. ultrasonic) transducers communicatively coupled to the laptop computing device (not shown). Additionally, or alternatively, the audio effect controller 316 may measure or cause to be measured the position or distance of the user based on images or video of the user obtained by one or more cameras of or communicatively coupled to the laptop computing device (not shown). Additionally, or alternatively, the audio effect controller 316 may measure or cause to be measured the position or the distance of the user based on measurements by one or more other types of optical or optoelectronic sensors of or communicatively coupled to the laptop computing device (not shown), such as light detection and ranging (LiDAR) sensors, infrared (IR) sensors, or any other suitable type of such sensor.

The characteristic of ambient sound in the vicinity of the laptop computing device may comprise any suitable characteristic that may indicate an aspect of the ambient sound which may affect how audio is projected from the audio endpoint device for outputting the audio signal(s) A (in this example, the speaker(s) 306) and which may be compensated for to provide for improved audio performance.

For example, the characteristic of the ambient sound in the vicinity of the laptop computing device may comprise a characteristic of one or more selected frequency components of the ambient sound, such as a power level of the one or more selected frequency components of the ambient sound. Such a characteristic may indicate a level of noise in the environment in which the laptop computing device is disposed. Such noise may be compensated for by the audio effect controller 316 by causing one or more noise cancelling audio effects to be implemented, for example.

Additionally, or alternatively, the characteristic may be indicative of certain classes of noise or specific types of sound, such as speech, for example.

The audio effect controller 316 may determine the characteristic of the ambient sound in any suitable way. For example, the audio effect controller 316 may obtain and process one or more audio streams comprising ambient sound content captured by one or more audio capture devices communicatively coupled to the laptop computing device. Such processing may comprise processing based on noise classification or speech classification algorithms, for example.

In the example shown in FIG. 3 where the audio endpoint device for outputting the audio signal(s) A comprises the speaker(s) 306, which may be integrated within the laptop computing device, the system context may additionally comprise a contortion of the laptop computing device. The contortion of the laptop computing device may refer to a position of a lid portion of the laptop computing device (the lid portion comprising e.g. the display) relative to a base portion of the laptop computing device (the base portion comprising e.g. a keyboard). The contortion of the laptop computing device may affect how sound is projected from the one or more speakers 306, respective ones of which may be integrated in the lid portion or the base portion. For example, various contortions of the laptop computing device may obstruct audio output from the speaker(s) 306 and may therefore require compensation for optimal audio performance. Examples of different contortions are discussed further below.

The lid portion of the laptop computing device may be coupled to the base portion by way of one or more hinges. The display portion of the laptop computing device may be operable to rotate about various axes. For example, the laptop computing device may be operable in a so-called “clamshell” configuration in which the lid portion can open and close relative to the base portion by rotating about a first axis parallel to a lateral edge of the base portion. A particular rotational position of the lid portion about the first axis relative to the base portion may be referred to as a “pitch” of the lid portion. Additionally, the lid portion may be rotatable about a second axis orthogonal to the first axis, the second axis extending from a lower edge of the lid portion to an upper edge of the lid portion. A particular rotational position of the lid portion about the second axis relative to the base portion may be referred to as a “yaw” of the lid portion.

The laptop computing device may thus be operable in various distinct contortions. For example, the laptop computing device may be operable in: the clamshell configuration described above; a “tablet” or “tablet-like” configuration in which the lid portion is closed relative to the base portion and where the lid portion is rotated about the second axis such that the display of the lid portion is facing away from the base portion; a so-called “tent” configuration, the meaning of which is known in the art; and various other configurations.

In examples where the system context comprises the contortion of laptop computing device, the audio effect controller 316 may determine the contortion of the laptop computing device in any suitable way. For example, the audio effect controller 316 may query one or more hinge sensor(s) of the one or more hinges by way of the OS to determine the contortion of the laptop computing device. For example, the audio effect controller 316 may query said hinge sensor(s) to determine corresponding angles of the one or more hinges, which may indicate a pitch and/or a yaw of the lid portion of the laptop computing device.

The audio effect controller 316 may determine the one or more audio effects to be applied to one or more of the audio signal(s) A in dependence on the determined system context in any suitable way.

For example, one or more of the audio effect(s) determined by the audio effect controller 316 may be predetermined and configured to compensate for how predetermined aspects of the system context may affect the audio performance of the laptop computing device. Additionally, or alternatively, one or more of the audio effect(s) may be generated (e.g. in real-time) by the audio effect controller 316 or may comprise adapted variant(s) of predetermined audio effect(s), as adapted by the audio effect controller 316 (e.g. in real time).

In examples where the audio effect(s) determined by the audio effect controller 316 are predetermined or based on predetermined audio effect(s), such predetermined audio effects may be stored in the memory 310. Such stored audio effects may be in the form of one or more audio effect mappings. Each audio effect mapping may define a mapping between: respective ones of a plurality of different system contexts (or selected elements thereof); and respective sets of one or more audio effects. Each set of audio effect(s) may be configured to enhance the audio quality of audio signals to be played back in accordance with the system context (or selected elements thereof) mapped to that set of audio effect(s). Each audio effect mapping may have been generated by way of experimentation, by way of simulation or modelling, or in any other suitable way. As will be discussed further below, the audio effect controller 316 may be configured to determine the audio effect(s) in dependence on the system context by receiving one or more relevant audio effect mappings from the memory 310 and selecting one or more relevant sets of audio effect(s) therefrom in dependence on the system context (e.g. based on one or more predetermined rules or heuristics).

The configuration and number of the one or more audio effect mappings described above may depend on various factors, such as the composition of the system context (e.g. whether the system context comprises one or both of the audio context of the audio signal(s) A and the acoustic configuration of the laptop computing device).

In examples where the system context comprises the audio context of each of the audio signal(s) A (e.g. but not the acoustic configuration of the audio signal(s) A), the memory 310 may store an audio effect mapping defining a mapping between each audio context supported by the audio effect controller 316 and a corresponding set of one or more audio effects that are configured to enhance the audio quality of audio signals having that audio context.

In examples where the system context comprises the acoustic configuration of the laptop computing device (e.g. but not the audio context of the audio signal(s) A), the memory 310 may store an audio effect mapping defining a mapping between: respective ones of a plurality of different acoustic configurations (or selected elements thereof); and respective sets of one or more audio effect(s). Each set of audio effect(s) may be configured to enhance the audio quality of audio signals (e.g. in general) played back in accordance the acoustic configuration (or selected elements thereof) mapped to that set of audio effect(s).

In examples where the system context comprises both the audio context and the acoustic configuration of the laptop computing device, the memory 310 may store, for each audio context supported by the audio effect controller 316, an associated audio effect mapping. Each audio effect mapping may define, for its associated audio context, a mapping between: respective ones of a plurality of different acoustic configurations (or selected elements thereof); and respective sets of one or more audio effect(s). Each set of audio effect(s) may be configured to enhance the audio quality of audio signals having the audio context associated with the audio effect mapping and to be played back in accordance the acoustic configuration (or selected elements thereof) mapped to that set of audio effect(s).

Any one or more of the above-described audio effect mappings may be specific to the speakers 306, whereby the audio effects defined therein may additionally be configured to compensate for one or more (e.g. physical or audio) characteristics of the speakers 306, to provide for e.g. excursion prevention or resonance distortion prevention. In such examples, the characteristic(s) of the speakers 306 or the audio effects required to compensate for these characteristics may be known based on information provided by the manufacturer of the speaker(s) 306.

Additionally, the memory 310 may store variants of any one or more of the above-described audio effect mappings that are specific to one or more other audio endpoints or audio endpoint types, such as the second audio endpoint device 502 described in relation to FIG. 5. In such examples each such variant of the one or more audio effect mappings may define audio effects that are tailored to that particular audio endpoint or audio endpoint type. In this way, the audio effect controller 316 may accommodate bespoke audio processing for different audio endpoint devices or different types of audio endpoint devices.

As discussed above, the laptop computing device may support a plurality of user accounts. The audio effect controller 316 may be configured to maintain different variants of any one or more of the audio effect mappings discussed herein for different user accounts to accommodate user preferences. Accordingly, the audio effect(s) determined by the audio effect controller 316 may may depend on the currently active user. It may that a user can modify or adapt the predetermined mapping associated with their user account by way of user input through a graphical user interface executed by the CPU 308, for example.

As discussed above, in addition to or as an alternative to the audio effect controller 316 determining audio effect(s) based on predetermined audio effects stored in audio effect mapping(s), the audio effect controller 316 may be configured to generate audio effect(s) in dependence on the system context (or selected elements thereof) or to adapt predetermined audio effects in dependence on the system context (or selected elements thereof). As an illustrative example, in examples where the system context comprises the acoustic configuration comprising the characteristic of ambient sound in the vicinity of the laptop computing device, this element of the acoustic configuration may be omitted from the audio effect mappings described above and instead the audio effect controller 316 may be configured to (e.g. in real-time) generate one or more audio effects or adapt one or more predetermined audio effects configured to compensate for the determined characteristic of ambient sound, such as to compensate for masking of audio signals played back by the speakers 306 that may result from the determined characteristic of ambient sound. Additionally, or alternatively, in examples where the system context comprises the acoustic configuration comprising the position or the distance of the user relative to the audio endpoint device, this element of the acoustic configuration may be omitted from the audio effect mappings described above and instead the audio effect controller 316 may be configured to (e.g. in real-time) generate one or more audio effects or adapt one or more predetermined audio effects configured to compensate for the determined position or distance of the user.

The following further describes how the audio effect controller 316 may determine the one or more audio effects based on the above-described audio effect mapping(s) with reference to first and second examples. However, it will be appreciated that these examples are merely for illustrative purposes and that the present disclosure is not so limited.

In the first example, the system context may comprise both the audio context of the audio signal(s) A and the acoustic configuration of the laptop computing device, and the audio signal(s) A may consist of a first audio signal A1 having a first audio context. The acoustic configuration may comprise the orientation of the laptop computing device, the contortion of the laptop computing device, and the characteristic of ambient sound in the vicinity of the laptop computing device.

The audio effect controller 316 may receive a first audio effect mapping associated with the first audio context from the memory 310. The first audio effect mapping may define a mapping between: respective ones of a plurality of combinations of different orientations and different contortions of the laptop computing device; and respective set(s) of one or more audio effect(s). Each set of audio effect(s) may be configured to enhance the audio quality of audio for audio signals having the first audio context played back by the laptop computing device when orientated and contorted in accordance with the orientation and contortion mapped to that set of audio effect(s). The audio effect controller 316 may select the set of audio effect(s) defined in the first audio effect mapping that are mapped to the combination of laptop orientation and contortion that is most relevant to the determined orientation and contortion of the laptop computing device. This set of audio effect(s) may be referred to as a first set of audio effect(s). The audio effect controller 316 may determine which combination of laptop orientation and contortion defined in the first audio effect mapping is the most relevant in any suitable way, such as based on one or more predetermined rules or heuristics. As an illustrative example, the first audio effect mapping may list the plurality of combinations of different orientations and different contortions in order of priority. The audio effect controller 316 may first determine whether the combination having the highest priority is sufficiently similar to the determined orientation and contortion of the laptop computing device. If it is, the audio effect controller 316 may determine that combination of orientation and contortion to be the most relevant. If it is not, the audio effect controller 316 may repeat the above process for the combination of laptop orientation and contortion defined in the first audio effect mapping having the next highest priority, and so on.

Having selected the first set of audio effect(s) defined in the first audio effect mapping, the audio effect controller 316 may adapt the selected set of audio effects or add one or more further audio effects thereto in dependence on the determined characteristic of ambient sound to compensate for masking of the audio signal A1 by the ambient sound. The audio effect controller 316 may then cause application of the above audio effects to the audio signal A1.

The second example corresponds to the first example with the exception that the audio signal(s) A comprise the first audio signal A1 and the second audio signal A2, the system context comprises the audio context of each of the first and second audio signals A1, A2, and the acoustic configuration does not comprise the characteristic of ambient sound.

In the second example, the audio effect controller 316 may be configured to attempt to determine audio effects to enhance the audio quality of both the first and the second audio signals A1, A2. The audio effect controller 316 may receive the first audio effect mapping associated with the first audio context discussed above in relation to the first example and a second audio effect mapping associated with the second audio context. The second audio effect mapping may be configured similarly to the first audio effect mapping with the exception that each set of audio effect(s) of the second audio effect mapping may be configured to enhance the audio quality of audio signals having the second audio context. The audio effect controller 316 may determine the first set of audio effect(s) to be applied to the first audio signal A1 based on the first audio effect mapping in accordance with the first example. The audio effect controller 316 may similarly determine a second set of audio effect(s) to be applied to the second audio signal A2 based on the second audio effect mapping.

The audio effect controller 316 may determine whether any of the first set of audio effect(s) conflict with any of the second set of audio effects(s). An example of audio effects that may conflict with each other may be incompatible EFX effects, although it will be appreciated that there may be other types of conflicting audio effects.

If the audio effect controller 316 determines that there is no conflict between any of the audio effects of the first and second sets of audio effect(s), then the audio effect controller 316 may cause application of the first set of audio effects to the first audio signal A1 and the second set of audio effects to the second signal A2. Accordingly, each of the first and second audio signals A1, A2 may have different audio effects applied thereto to selectively enhance the quality of each of the first and thee second audio signals A1, A2.

If the audio effect controller 316 determines that there is a conflict between any of the audio effects of the first and second sets of audio effect(s), the audio effect controller 316 may be configured to prioritize a particular one of the first and second sets of audio effect(s), for example, based on one more predetermined rules or heuristics. For example, the different audio contexts supported by the audio effect controller 316 may have predetermined different priorities, and the audio effect controller 316 may be configured to prioritize the application of the one of the first and second sets of audio effects associated with the audio context having the greater priority. As an illustrative example, the first audio context may have a higher priority than the second audio context. Accordingly, the audio effect controller 316 may prioritize application of the first set of audio effects and may apply the first set of audio effects to the first audio signal A1. The audio controller may avoid the application of conflicting ones of the second set of audio effects in any suitable way, for example by dispensing with the second set of audio effects and causing application of only the first set of audio effects to the first audio signal A1.

The one or more audio effects may comprise any type of audio effect and may be configured to be applied at any stage during combining of the audio signal(s), such as by the audio engine of the CPU 308, where applicable. For example, the one or more audio effects may comprise any one or any combination of SFX, MFX, and EFX.

It will be appreciated that reference to a particular audio effect or particular set of audio effects being applied to a particular audio signal (such as the audio signal A1) may encompass or more of those audio effects additionally being applied to other audio signals (such as the audio signal A2). As an illustrative example, the first set of audio effect(s) described above may include an EDX effect and thus application of the first set of audio effect(s) to the first audio signal A1 may encompass applying the EDX effect to all other audio signals to be output by the same audio endpoint device, such as the audio signal A2.

The one or more audio effects may comprise any one or more of: acoustic echo cancellation (AEC), noise suppression (NS), deep noise suppression, acoustic gain control (AGC), beam forming (BF), constant tone removal, equalization, loudness equalization, bass boost, virtual surround, virtual headphones, speaker fill, room correction, bass management, environment effects, speaker protection, speaker compensation, dynamic range compression, excursion prevention, resonance distortion prevention, rattle distortion reduction, distortion limiting, crossover filtering, spatial processing, virtual and/or dynamic bass enhancement.

Having determined the one or more audio effects for application to the audio signal(s), the audio effect controller 316 may cause application of the determined one or more audio effects to one or more of the audio signal(s) A. For example, audio effect controller 316 may output the one or more audio effects to the CPU 308. For example, the audio effect controller 316 may communicate with one or more existing APOs to dynamically adjust the audio effects implemented thereby to cause application of the determined one or more audio effects to the one or more audio signal(s) A. In such examples, the processed audio signal SA may comprise respective components corresponding to respective ones of the audio signal(s) A, where one, some, or each of the components may have one, some, or each of the audio effect(s) determined by the audio effect controller 316 applied thereto.

### FIG. 4 is a flow diagram illustrating an example audio processing flow for the system 300 of FIG. 3.

One or more applications 402 running on the main circuitry 302 may each generate an audio signal. In the example shown, first, second, and third audio signals A1, A2, A3 are generated. The first, second, and third audio signals A1, A2, and A3 may be similar to those discussed above in relation to FIG. 2.

In the example shown in FIG. 4, the audio effect controller 316 may determine a system context comprising an audio context of the audio signals A1, A2, A3 and an acoustic configuration, such as a contortion of the laptop computing device. For example, the laptop computing device may be configured in a tent-like configuration.

The audio effect controller 316 may determine the audio context of the audio signals A1, A2, A3 and the contortion of the laptop computing device in accordance with examples discussed herein. The audio context of the audio signals A1, A2 may indicate said signals to comprise media content. The audio context of the audio signal A3 may indicate said signal to comprise speech content.

The audio effect controller 316 may determine one or more audio effects to be applied to the audio signals A1, A2, A3 in dependence on the determined system context, in accordance with examples discussed herein. For example, the audio effect controller 316 may select a respective set of one or more audio effects mapped to one of a plurality of different system contexts (or selected elements thereof) defined in an audio effect mapping, wherein said one of the plurality of different system contexts (or selected elements thereof) is the most relevant to the system context determined by the audio effect controller 316. The selected set of audio effects, which are selected in dependence not just the audio context of the audio signals but additionally on the acoustic configuration (in this example, contortion) of the laptop computing device may provide for an improved audio performance of the laptop computing device when playing back the first, second, and third audio signals A1, A2, A3 relative to the laptop computing device discussed in relation to FIGS. 1 and 2. For example, the selected audio effect(s) may compensate for the acoustic configuration of the laptop computing device in view of the particular types of audio content being output thereby to provide for a desirable or an optimal audio performance.

The audio effect controller 316 may output the determined audio effects to the CPU 302 (as indicated by the arrow 404 in FIG. 4) in accordance with examples discussed herein, which may responsively mix the audio signals A1, A2, A3 and apply the determined one or more audio effects thereto, as illustrated by the dashed box 406 shown in FIG. 4.

It will be appreciated that the processing flow 400 shown in FIG. 4 is an example only, and the audio effect controller 316 may determine one or more audio effects to be applied to any number of audio signals based on any of the system contexts discussed herein.

While, in the examples described above in relation to FIGS. 3 and 4, the audio effect controller 316 outputs the determined one or more audio effects to the CPU 308 for application to the audio signal(s) A, it will be appreciated that this merely for illustrative purposes and that the present disclosure is not so limited. In other examples, the DSP included in the main circuitry 302, the DSP included in the peripheral audio circuitry 304, or other audio circuitry included in the system 300 (not shown), may be configured to apply the determined audio effect(s) to the audio signal(s) A instead of the CPU 308. In such examples, the audio effect controller 316 may output the determined one or more effects to the DSP included in the main circuitry 302, the DSP included in the peripheral audio circuitry 304, or to said other audio circuitry included in the system 300. In such examples, the CPU 308 may be configured to output the audio signal(s) A to the DSP included in the main circuitry 302, the DSP included in the peripheral audio circuitry 304, or to said other audio circuitry (e.g. instead of the processed audio signal SA). The entity configured to apply the one or more audio effects determined by the audio effect controller 316 may referred to generally as “audio effect circuitry”.

FIG. 5 is a schematic diagram of another example of the system 500 which is a variation of the system 300, like parts being given like reference numerals.

The system 500, which may be integrated into a laptop computing device, is communicatively coupled to second audio endpoint device 502. The second audio endpoint device 502 may comprise (wired or wireless) headphones or earphones, or one or more (wired or wireless) speakers, for example. The second audio endpoint device 502 may be communicatively coupled to the system 500 by way of a wired or wireless connection, as indicated by the arrow 508. The second endpoint device 502 may comprise one or more audio transducers 506.

In addition to or as an alternative to running one or more applications each generating an audio signal A for outputting by the first audio endpoint device (i.e. the one or more speakers 306), the CPU 308 may run one or more applications each of which may generate an audio signal A* for outputting by the second audio endpoint device 502. For example, the audio signal(s) A* may be output by said applications instead of the audio signal(s) A, may be output by said applications substantially concurrently with the audio signal(s) A, or may be output by said applications at different time than the audio signal(s) A. The following assumes that the audio signal(s) A* are output substantially concurrently with the with audio signal(s) A. However, it will be appreciated that this is merely for illustrative purposes and that the present disclosure is not so limited.

In the example shown in FIG. 5, the audio effect controller 316 may be configured to determine a first system context associated with the first audio endpoint device (the speaker(s) 306) and determine a second system context associated with the second audio endpoint device 502. The first system context may be in accordance with examples discussed above in relation to FIGS. 3 and 4. The second system context may be similar to the system context discussed above in relation to the FIGS. 3 and 4 with the exception that it may not comprise aspects or elements of the acoustic configuration of the laptop computing device specific to the speaker(s) 306, such as the contortion of the laptop computing device.

The audio effect controller 316 may be configured to determine a first set of one or more audio effects for application to the audio signal(s) A in dependence on the first system context, in accordance with examples discussed herein. The audio effect controller 316 may additionally be configured to determine a second set of one or more audio effects in dependence on the second system context in a similar way.

The audio effect controller 316 may output the first and the second audio effects to an audio effect circuitry or to respective audio effect circuitries (such as any one or more of the audio effect circuitries described herein), which may responsively apply the first set of audio effect(s) to the audio signal(s) A to thereby generate a first processed audio signal SA1, and which may responsively apply the second set of audio effect(s) to the audio signal(s) A* to thereby generate a second processed audio signal (not shown). In the example shown in FIG. 5, the audio effect circuitry corresponds to the CPU 308, however, it is to be understood that the present disclosure is not so limited.

The system 500 may then cause output of the first and second processed audio signals by way of the first and second audio endpoint devices, respectively (e.g. substantially simultaneously).

For example, the CPU 308 may output the first processed audio signal SA1 to the peripheral audio processing circuitry 304, which may generate a first analog signal SO1 based thereon and which in turn may be played back by the first audio endpoint device (the speaker(s) 306).

The second audio endpoint device 502 may comprise second peripheral audio circuitry 504 similar to the peripheral audio circuitry 304. In such examples, the CPU 308 may output the second processed audio signal SA2 to the peripheral audio circuitry 504 for amplification and/or conversion to the analog domain for output by the one or more audio transducers 506 of the second audio endpoint device 502. Alternatively, it may be that the second audio endpoint device 502 does not comprise the second peripheral audio circuitry 504. In such examples, the CPU 308 may output the second processed audio signal (not shown) to the peripheral audio circuitry 304 for generation of a second analog signal (not shown). The second analog signal may then be output to the second audio endpoint device 504 for playback by the one or more audio transducers 506 thereof.

While the systems and methods described hereinabove have been described in the context of laptop computing devices, it will be understood that the invention may also apply other types of devices. For example, each of the system 300 and the system 500 may alternatively be integrated into any one of a desktop computer, a mobile computing device, a mobile telephone, a smartphone, a tablet computer, a wearable device, a home entertainment system, an automotive or vehicle audio system, a games console, a remote control device, a home automation controller or a domestic appliance, a toy, a robot, an audio player, a video player, or any other type computing device having any other type of computer form factor. In such examples, it will be appreciated that any reference to “a laptop computing device” hereinabove may alternatively refer to any one of the above device types.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A method of processing an audio signal in a laptop computing device, the audio signal for outputting by an audio endpoint device, the method comprising:
determining an audio context of the audio signal;
determining an acoustic configuration of the laptop computing device;
determining one or more audio effects in dependence on the audio context and the acoustic configuration of the laptop computing device; and
applying the one or more audio effects to the audio signal to generate a processed audio signal.

2. The method of claim 1, wherein the audio context comprises one or more of:
a. a type of an application from which the audio signal derives;
b. a specific application from which the audio signal derives;
c. a category of audio content included in the audio signal.

3. The method of claim 2, wherein the type of the application comprises any one of:
a. a voice over internet protocol, VOIP, application;
b. a game;
c. a media player;
d. a web browser application.

4. The method of claim 2, wherein the category of audio content comprises:
a. movie content;
b. media content;
c. game chat content;
d. speech content;
e. communications content;
f. alert content;
g. sound effect content;
h. game media content;
i. game effect content.

5. The method of claim 1, wherein the acoustic configuration comprises any one or more of:
a. a type of the audio endpoint device;
b. a configuration of the audio endpoint device;
c. a characteristic of ambient sound in a vicinity of the laptop computing device;
d. a distance or a position of a user relative to the audio endpoint device.

6. The method of claim 5, wherein the characteristic of ambient sound is indicative of a predetermined type of sound, and wherein the predetermined type of sound is one or both of:
a. a predetermined type of noise;
b. speech.

7. (canceled)

8. The method of claim 5, wherein the characteristic of the ambient sound comprises a characteristic of one or more selected frequency components of the ambient sound, and wherein the characteristic of the one or more selected frequency components of the ambient sound comprises a power level of the one or more selected frequency components of the ambient sound.

9. (canceled)

10. The method of claim 1, wherein the audio endpoint device comprises one or more speakers of the laptop computing device, and wherein the acoustic configuration of the laptop computing device comprises any one or more of:
a. an orientation of the one or more speakers;
b. an orientation of a display of the laptop computing device;
c. a number of the one or more speakers;
d. a contortion of the laptop computing device.

11. The method of claim 1, wherein the one or more audio effects comprise any one or more of:
a. baseline speaker protection;
b. excursion prevention;
c. resonance distortion prevention;
d. rattle distortion reduction;
e. distortion limiting;
f. crossover filtering;
g. spatial processing;
h. equalization;
i. virtual and/or dynamic bass enhancement.

12. The method of claim 1, further comprising:
determining that the audio signal derives from an application associated with a currently active user account of the laptop computing device; and
selectively determining the audio context of the audio signal in dependence on said determination.

13. The method of claim 1, wherein determining the one or more audio effects comprises selecting the one or more audio effects from a predetermined audio effect mapping associated with the audio context, the predetermined audio effect mapping defining a mapping between: respective ones of a plurality of different acoustic configurations or selected elements thereof; and respective sets of one or more audio effects.

14. The method of claim 13, wherein each of the sets of the one or more audio effects defined in the predetermined audio effect mapping are configured to compensate for one or more characteristics of the audio endpoint device.

15. (canceled)

16. The method of claim 1, wherein the audio signal is a first audio signal for outputting by the audio endpoint device, and wherein the one or more audio effects are one or more first audio effects, the method further comprising:
determining an audio context of a second audio signal for outputting by the audio endpoint device;
determining one or more second audio effects in dependence on the audio context of the second audio signal and the acoustic configuration of the laptop computing device; and
applying the one or more second audio effects to the second audio signal;
wherein the processed audio signal comprises:
a first component corresponding to the fist audio signal with the one or more first audio effects applied thereto; and
a second component corresponding to the second audio signal with the one or more second audio effects applied thereto.

17. The method of claim 1 further comprising causing the processed audio signal to be output by the audio endpoint device.

18. The method of claim 17, wherein the audio endpoint device comprises one or more speakers of the laptop computing device.

19.-20. (canceled)

21. A method of determining one or more audio effects for processing an audio signal in a laptop computing device, the method comprising:
determining an audio context of the audio signal;
determining an acoustic configuration of the laptop computing device;
determining one or more audio effects in dependence on the audio context and the acoustic configuration of the laptop computing device; and
outputting audio effect data indicative of the one or more audio effects to be applied to the audio signal.

22. An apparatus comprising:
processing circuitry; and
memory comprising software instructions which when executed by the processing circuitry cause the processing circuitry to:
determine an audio context of an audio signal for outputting by an audio endpoint device of or communicatively coupled to a laptop computing device;
determine an acoustic configuration of the laptop computing device;
determine one or more audio effects in dependence on the audio context and the acoustic configuration of the laptop computing device; and
apply the one or more audio effects to the audio signal to generate a processed audio signal.

23. The apparatus of claim 22, wherein the memory further comprises software instructions which when executed by the processing circuitry cause the processing circuitry to output the one or more processed audio signals by the audio endpoint device.

24. A system of a laptop computing device, the system comprising:
main circuitry, comprising:
a central processor; and
memory comprising software instructions which, when executed by the central processor, cause the central processor to output an audio signal;
an audio effect controller configured to:
determine an audio context of the audio signal;
determine an acoustic configuration of the laptop computing device;
determine one or more audio effects in dependence on the audio context and the acoustic configuration of the laptop computing device; and
output the one or more audio effects; and
audio effect circuitry configured to:
receive the audio signal; and
apply the one or more audio effects to the audio signal to generate a processed audio signal.

25. The system of claim 24, further configured to output the processed audio signal by an audio endpoint device of or communicatively coupled to the laptop computing device.

26. An electronic device comprising the apparatus of claim 22.

27. The electronic device of claim 26, wherein the electronic device comprises one of a laptop computing device, a wearable device, a mobile computing device, a tablet computer, a games console, a remote control device, a home automation controller or a domestic appliance, a toy, a robot, an audio player, a video player, a mobile telephone, and a smartphone.

28. A method of processing an audio signal in a laptop computing device, the method comprising:
determining a system context, the system context comprising at least a contortion of the laptop computing device;
determining one or more audio effects in dependence on the system context of the laptop computing device; and
applying the one or more audio effects to the audio signal to generate a processed audio signal.

29. At least one non-transitory machine-readable medium comprising software instructions which, when executed by processing circuitry, cause the processing circuitry to implement the method of claim 1.
